(19) United States
(12) Patent Application Publication
(10) Pub. No.: US 2011/0087833 A1
(43) Pub. Date: Apr. 14, 2011

(54) LOCAL NONVOLATILE WRITE-THROUGH CACHE FOR A DATA SERVER HAVING NETWORK-BASED DATA STORAGE, AND RELATED OPERATING METHODS

(75) Inventor: Nicholas T. JONES, Austin, TX (US)

(73) Assignee: ADVANCED MICRO DEVICES, INC., Austin, TX (US)

(21) Appl. No.: 12/576,133

(22) Filed: Oct. 8, 2009

(51) Int. Cl. G06F 12/08; G06F 12/00

(52) U.S. Cl. 711/104; 711/142; 711/114; 711/E12.001; 711/E12.026

(57) ABSTRACT

A data server, a host adapter system for the data server, and related operating methods facilitate data write and read operations for network-based data storage that is remotely coupled to the data server and for non-network-based data storage in a locally attached cache device. The host adapter system includes a local storage controller module and a network storage controller module. The local storage controller module is utilized for a locally attached, nonvolatile, write-through cache device of the data server. The network storage controller module is utilized for a network-based data storage architecture of the data server. The storage controller modules support concurrent writing of data to the local cache storage and the network-based storage architecture. The storage controller modules also support reading of server-maintained data from the local cache storage and the network-based storage architecture.

### TECHNICAL FIELD

Embodiments of the subject matter described herein relate generally to computer devices, systems, and architectures. More particularly, embodiments of the subject matter relate to a data server system that uses both network-based data storage and locally attached hard disk storage for redundancy.

### BACKGROUND

Data can be shared among computers in many various forms. One popular form that facilitates data sharing is known as the client/server model, which is commonly realized as a client/server network. In a client/server network, a server machine or system executes a server application to fulfill requests from any number of client applications. Servers often manage the reading, writing, and storage of vast amounts of data, to which one or many client applications have access.

Many data intensive client/server systems utilize network-based data storage, such as a storage area network (SAN) or network attached storage (NAS). Network-based data storage can be used to remotely store very large amounts of data for one or more servers. SANs can be used to simplify and centralize data storage among many servers. In addition, a SAN can facilitate efficient and effective data backups, server replication, drive hot-swapping, and volume size adjustment. Moreover, modern network-based storage systems can support data transfer at several gigabits per second. Although network-based storage has many advantages and benefits, some server operations and workloads are better supported by local storage that is resident at or directly attached to the server machine. For example, large database workloads can be very memory-intensive and typically require random access to data maintained in one or more databases. These and other workload types do not usually rely on network-based storage due to associated performance penalties, such as read/write processing latency.

### BRIEF SUMMARY OF EMBODIMENTS

A method of operating a data server system is provided. The data server system includes a data server, a network-based data storage architecture coupled to the data server, and a non-network-based nonvolatile write-through cache device locally attached to the data server. The method begins by receiving instructions to write data. The method continues by controlling storage of the data in the non-network-based nonvolatile write-through cache device, in accordance with the instructions. The method also controls redundant storage of the data in the network-based data storage architecture, in accordance with the instructions. As a result, redundant instantiations of the data are stored at the non-network based write-through cache device and at the network-based data storage architecture.

Another method of operating a data server system is provided. This method begins by receiving instructions to read designated data that was previously written by the data server. The method proceeds by issuing a local read request for the designated data, the local read request calling for data stored in the non-network-based nonvolatile write-through cache device. The method also issues a network read request for the designated data, the network read request calling for data stored in the network-based data storage architecture.

Also provided is a host adapter system for a data server. The host adapter system includes a local storage controller module and a network storage controller module. The local storage controller module is for a locally attached nonvolatile write-through cache device of the data server. The local storage controller module is configured to control writing of server-maintained data at the locally attached nonvolatile write-through cache device. The network storage controller module is for a network-based data storage architecture of the data server. The network storage controller module is configured to control duplicate writing of the server-maintained data at the network-based storage architecture. During operation, the local storage controller module issues a local read request for designated data maintained by the data server, where the local read request is intended for the locally attached nonvolatile write-through cache device. In addition, the network storage controller module concurrently issues a network read request for the designated data, where the network read request is intended for the network-based storage architecture.

A computer-readable medium having computer-executable instructions stored thereon is also provided. When the computer-executable instructions are executed by a data server machine, they cause the data server machine to control a locally attached nonvolatile write-through cache device of the data server machine to perform local write and read operations for data maintained by the data server machine. The computer-executable instructions also cause the data server machine to control a network-based storage architecture of the data server machine to perform network write and read operations for data maintained by the data server machine. As a result, server-maintained data is redundantly stored at both the locally attached nonvolatile write-through cache device and the network-based storage architecture.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of a simplified embodiment of a network-based storage system;

FIG. 2 is a schematic representation of a simplified embodiment of a storage area network suitable for use in the network-based storage system depicted in FIG. 1;

FIG. 3 is a schematic representation of a simplified embodiment of a data server that is suitable for use in the network-based storage system depicted in FIG. 1;

FIG. 4 is a schematic representation of an embodiment of a data server system that cooperates with a nonvolatile locally attached write-through cache;

FIG. 5 is a schematic representation of another embodiment of a data server system that cooperates with a nonvolatile locally attached write-through cache;

FIG. 6 is a diagram of exemplary software/logical components associated with the data server system depicted in FIG. 5; and

FIG. 7 is a flow chart that illustrates an embodiment of a local write-through cache control process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. “Processor-readable medium” or “machine-readable medium” or “computer-readable medium” may be used interchangeably here to refer to any medium that can store or transfer information. Examples of a computer-readable medium include an electronic circuit, a semiconductor memory device, a ROM, a flash memory, an erasable ROM (EROM), a floppy diskette, a CD-ROM, an optical disk, a hard disk, or the like.

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

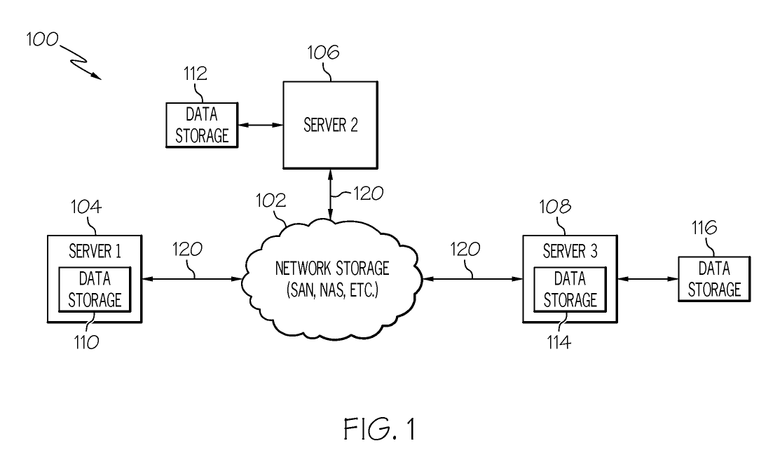

FIG. 1 is a schematic representation of a simplified embodiment of a network-based storage system 100. The system 100 employs a network-based data storage architecture 102, which may implement or utilize a SAN (or SAN technology), a NAS (or NAS technology), or the like. The depicted embodiment of the system 100 supports a plurality of data servers, which may (but need not) be independent and distinct from one another. This example supports a first data server 104, a second data server 106, and a third data server 108. In practice, an embodiment of the system 100 could support any number of data servers, including only one data server, more than three data servers, or less than three data servers.

Each data server shown in FIG. 1 represents a physical machine or computer device that is suitably configured to support traditional data server and/or file server functionality, along with the local write-through cache functionality described here. Any of these data servers could operate with locally attached internal/integrated data storage hardware, and/or locally attached external data storage hardware (as described in more detail below). In this regard, the first data server 104 is shown with locally attached internal/integrated data storage hardware 110, the second data server 106 is shown with locally attached external data storage hardware 112, and the third data server is shown with both locally attached internal/integrated data storage hardware 114 and locally attached external data storage hardware 116. As explained in more detail below, a locally attached data storage hardware device can serve as a non-network-based, nonvolatile, write-through cache device for a data server of the system 100.

The network-based data storage architecture 102 provides primary, additional, supplemental, and/or redundant data storage capacity for each data server. In practice, each data server is coupled to, and communicates with, the network-based data storage architecture 102 using a respective network data communication link 120 that supports the physical transport requirements and data communication protocols of the network-based data storage architecture 102. In certain embodiments, the network-based data storage architecture 102 (and, therefore, each network data communication link 120) is configured for compatibility with a storage interface technology such as, without limitation: Fiber Channel; Internet Small Computer System Interface (iSCSI); Gigabit Ethernet (GbE); Advanced Technology Attachment over Ethernet (AoE); Fiber Channel over Ethernet (FCoE); Fiber Channel over IP (FCIP); HyperSCSI; Internet Fiber Channel Protocol (iFCP); InfiniBand; or similar unified storage technologies.

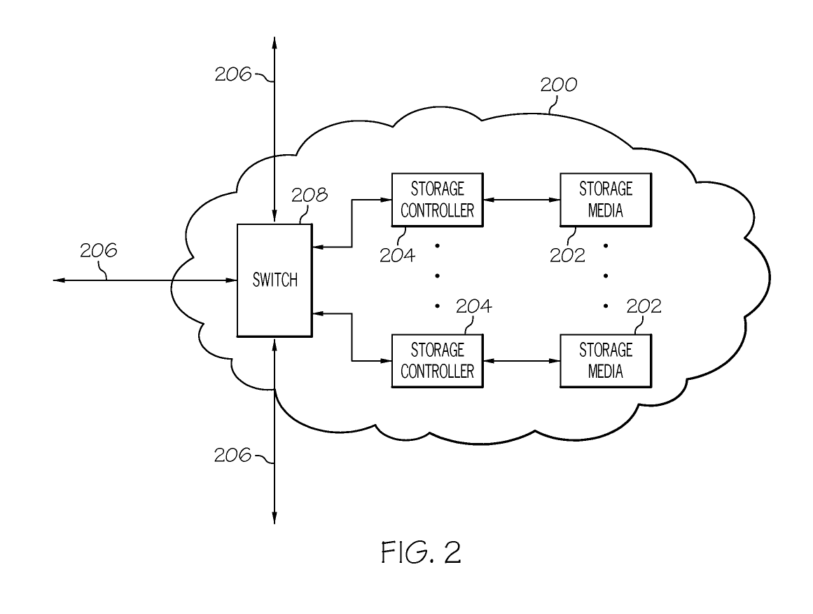

FIG. 2 is a schematic representation of a simplified embodiment of a SAN 200 suitable for use in the network-based storage system 100. As is well understood, the SAN 200 typically includes one or more storage media devices 202 that provide remote data storage for data server machines supported by the SAN 200. The illustrated embodiment of the SAN 200 includes one storage controller 204 (which may be realized as a card, a processor board, a logical module, a hardware device, or the like) for each storage media device 202, although other configurations are possible. For example, a single SAN storage controller can support multiple storage media devices (such as hard drives), and a one-to-one relationship is not required. The ellipses in FIG. 2 indicate that any number of storage media devices 202 and any number of storage controllers 204 may be found in a practical implementation of the SAN 200.

A given storage media device 202 in the SAN 200 could be realized using any appropriate platform or device technology. For example, a storage media device 202 may utilize or be embodied as any of the following, without limitation: one or more hard disks; one or more magnetic tapes; one or more optical disks; flash memory; or the like. In certain data server systems, the storage media devices 202 are configured and controlled to support write and read operations for one or more data server machines coupled to the SAN 200.

A storage controller 204 may be physically realized in a common device housing or enclosure, along with one or more storage media devices 202 that it manages. Each storage controller 204 functions in a conventional manner to regulate, manage, and control data read/write operations for one or more of the storage media devices 202. For the simplified embodiment described here, each storage controller 204 is responsible for data read/write operations of one storage media device 202. Accordingly, FIG. 2 depicts each storage controller 204 coupled to a respective storage media device 202. In practice, however, a single storage controller can support multiple storage media devices (such as hard drives), and a one-to-one relationship is not required.

As mentioned above with reference to FIG. 1, the SAN 200 could provide remote network-based data storage for one or more different data server machines. For consistency with FIG. 1, the SAN 200 is depicted with three network data communication links 206 associated with three data server machines (not shown). The illustrated embodiment of the SAN 200 also includes a switch 208, switching fabric, or an equivalent switching architecture that communicatively couples the network data communication links 206 to the storage controllers 204. The switch 208 enables the SAN 200 to route data from the storage media devices 202 to any of the supported data server machines, via the storage controllers 204.

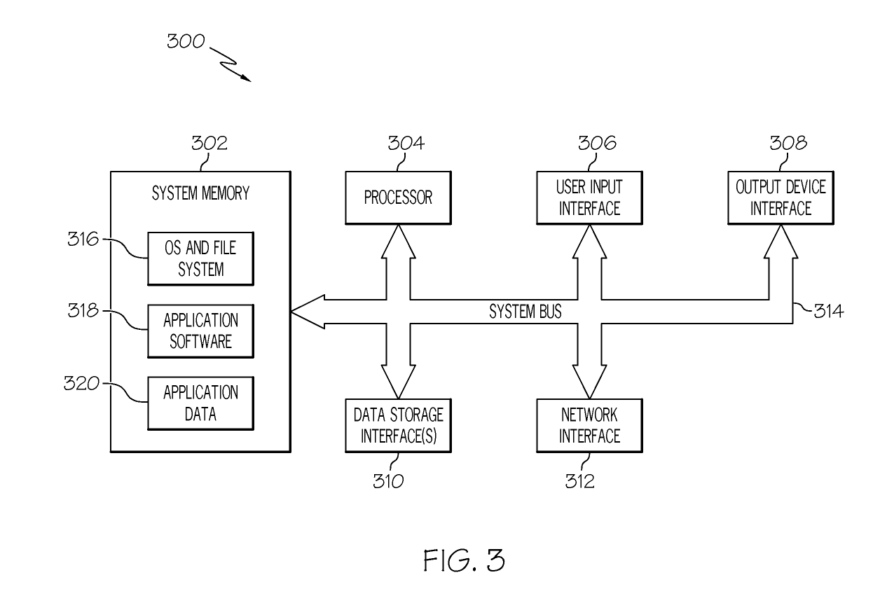

FIG. 3 is a schematic representation of a simplified embodiment of a data server 300 that is suitable for use in the network-based storage system 100. It should be appreciated that a practical deployment of the data server 300 will include additional hardware, software, and/or firmware components that are neither shown nor described in detail here. This exemplary embodiment of the data server 300 is not intended to suggest any limitation as to the scope of use or functionality of the described subject matter. Moreover, the data server 300 should not be interpreted as having any dependency or requirement relating to any one or combination of components depicted in FIG. 3.

The illustrated embodiment of the data server 300 includes, without limitation: an appropriate amount of system memory 302; a processor 304; a user input interface 306; an output device interface 308; at least one data storage interface 310; and a network interface 312. These and other elements of the data server 300 are coupled together using a system bus 314, which facilitates data communication between the elements of the data server 300. The system bus 314 may include or be implemented in accordance with known bus structures, including a memory bus, a memory controller, a peripheral bus, and a local bus using any of a variety of bus architectures. For example, and without limitation, the system bus 314 may utilize Peripheral Component Interconnect Express (PCIe) technology, Peripheral Component Interconnect (PCI), PCI Extended (PCI-X), or HyperTransport. Moreover, this lower level interconnect architecture need not be limited to physical connections—wireless technologies and protocols could also be implemented here.

The system memory 302 includes computer-readable media in the form of volatile and/or nonvolatile memory, e.g., read-only memory (ROM) and random access memory (RAM). The data server 300 may also include, cooperate with, or use EEPROM, flash memory, optical disk memory, magnetic storage media, or the like. In practice, the system memory 302 can be used to store computer-readable instructions, software, or programs associated with an operating system (OS), which typically includes a file system. In this regard, FIG. 3 depicts an OS and a file system driver 316 resident in the system memory 302. The system memory 302 may also be used to store application software 318 and related application data 320 for the data server 300. The application software 318 cooperates with the file system driver 316, which is used for writing and reading data as needed by the application software 318. Although not shown in FIG. 3, the system memory 302 may also be used to store a basic input/output system (BIOS) and other program modules used by the data server 300.

The processor 304 represents the main central processing unit (CPU) of the data server 300. In this regard, the processor 304 could be realized as one or more integrated circuit chips, and the processor 304 may include one or more independent processor cores, as is understood. In accordance with well known principles, the processor 304 executes certain computer-readable instructions to support the various functions and operations of the data server 300.

The user input interface 306 facilitates communication with one or more human-machine interface devices, such as a keyboard, a pointing device, a touchpad, a touch screen, or the like. The output device interface 308 facilitates communication with one or more output peripherals, such as a display monitor, a printer, speakers, or the like. The network interface 312 provides connectivity with an external data communication network, e.g., a local area network, a wide area network (such as the Internet), etc. In certain embodiments, the network interface 312 is implemented as an Ethernet interface. Alternatively, any networking protocol or technology that accommodates TCP/IP could be utilized for the network interface 312.

As described in more detail below, the data server 300 employs at least one data storage interface 310 that facilitates data communication with both a network-based data storage architecture (e.g., a SAN) and a non-network-based locally attached data storage architecture. In one embodiment, the data server 300 utilizes an integrated data storage interface that includes storage controller functionality for both the network-based data storage architecture and the non-network-based locally attached data storage architecture. Such an integrated data storage interface can be physically realized on the motherboard of the data server 300, physically implemented on a devoted plug-in card or circuit board, incorporated into an application-specific integrated circuit (ASIC) having additional functionality, or the like. In another embodiment, the data server 300 utilizes one data storage interface for the network-based data storage architecture, and a different and distinct data storage interface for the non-network-based data storage architecture. In this regard, the data server 300 could employ two physically distinct circuit boards, hardware components, plug-in cards, or other tangible means for implementing multiple data storage interfaces 310. Exemplary data storage interfaces that are compatible with network-based and non-network-based data storage architectures are described in more detail below.

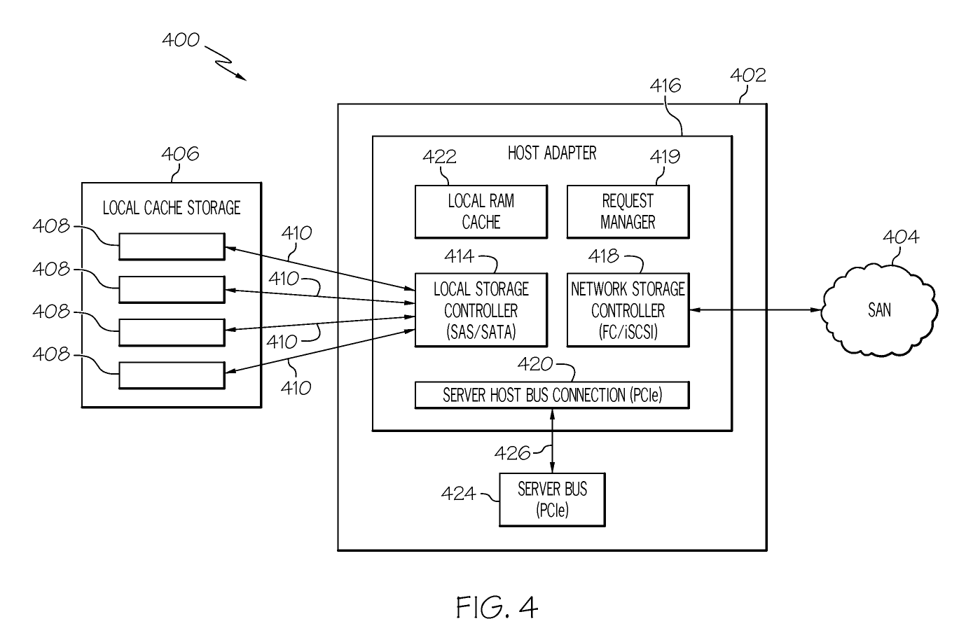

FIG. 4 is a schematic representation of an embodiment of a data server system 400 that is configured to support local write-through cache technology. The data server system 400 includes a data server 402, a network-based data storage architecture (e.g., a SAN 404) in communication with and operatively coupled to the data server 402, and non-network-based local cache storage 406 in communication with and operatively coupled to the data server 402. The data server system 400 uses the local cache storage 406 as a nonvolatile write-through cache for the data server 402. In this regard, data written by the data server 402 to the SAN 404 is also written to the local cache storage 406 such that redundant instantiations of the data are stored at both the SAN 404 and the local cache storage 406. In certain embodiments, the SAN 404 is configured in accordance with well known and conventional techniques and technologies. Indeed, the SAN 404 may be configured as described above for the SAN 200 (see FIG. 2). Accordingly, the SAN 404 will not be described in detail here.

The local cache storage 406 should be nonvolatile to ensure that its data is maintained in the event of a power down condition of the data server 402. Moreover, the local cache storage 406 is a “write-through” element in that the data server 402 will write data to the local cache storage 406 while also writing the same data redundantly to the SAN 404. This facilitates quick and rapid reading of data stored in the local cache storage 406 (relative to reading of the redundant data from the SAN 404).

The local cache storage 406 includes one or more nonvolatile data storage devices, elements, or components. Depending upon the embodiment, the local cache storage 406 may include or be realized as at least one hard disk drive, a Redundant Array of Independent Disks (RAID), at least one flash memory element, random access memory, or the like. In certain implementations, the local cache storage 406 is realized as a RAID 0 configuration that employs striping for quick data writing and reading, as is well understood. Alternatively, other RAID configurations could be utilized if so desired. The illustrated embodiment of the local cache storage 406 has four hard disk drives 408, each in data communication with the data server 402. The data storage capacity of the local cache storage 406 and of each individual hard disk drive 408 can be selected to suit the caching requirements of the data server 402, the applications supported by the data server 402, the workloads supported by the data server 402, and/or other practical operating considerations. In view of the decreasing cost of hard disk storage, a practical implementation of the local cache storage 406 could very easily and inexpensively provide many terabytes of storage capacity. That said, due to the finite capacity of the local cache storage 406, the data stored therein may need to be managed to ensure that the data server system 400 operates efficiently and effectively. For example, it may be desirable to preserve the most frequently used data in the local cache storage 406, while sacrificing (if necessary) data that is less frequently used. As another example, if the local cache storage 406 is full to capacity, then the data server system 400 could purge data stored therein in a first-in, first-out manner.

The local cache storage 406 is locally attached to the data server 402 such that it need not rely on any external network architecture, network data communication hardware, or network data communication protocols to transfer data to/from the data server 402. The local cache storage 406 may be realized as a locally attached external component (as depicted in FIG. 4) and/or as a locally attached component or element that is internal to or otherwise integrated into the data server 402. Thus, the local cache storage 406 could be physically located inside a housing, case, or hardware chassis of the data server 402.

The local cache storage 406 is coupled to the data server 402 using appropriate interconnection hardware, data communication paths, and/or data communication interface protocols. For example, one or more data communication links 410 can be used between the local cache storage 406 and the data server 402. The illustrated embodiment uses the data communication links 410 to couple the hard disk drives 408 to a local storage controller module 414 of the data server 402. Notably, the local cache storage 406, the data communication links 410, and the local storage controller module 414 are configured for compatibility with a storage interface technology that is suitable for making a direct, local, and non-network-based attachment. In certain embodiments, the local cache storage 406, the data communication links 410, and the local storage controller module 414 are compatible with one or more of the following storage interface technologies, without limitation: Small Computer System Interface (SCSI); Serial Attached Small Computer System Interface (SAS); Serial Advanced Technology Attachment (SATA); Universal Serial Bus (USB); FireWire; or Integrated Drive Electronics (IDE). In a typical implementation, the local cache storage 406, the data communication links 410, and the local storage controller module 414 will be compatible with SAS and/or SATA. This allows the local storage controller module 414 to quickly and easily perform data read and write operations with the local cache storage 406 while avoiding the overhead processing and latency that is typically associated with accessing data from a network-based data storage architecture.

For this embodiment, the local storage controller module 414 represents a component, element, or module of a host adapter system 416 for the data server 402. The host adapter system 416 may also include, without limitation: a network storage controller module 418; a data request manager 419 (or suitable control unit); a server host bus connection 420; and a local RAM cache device 422. The host adapter system 416 may be implemented on, realized as, or integrated into a plug-in card, a physical component board, a circuit board, a motherboard, a logical module, a hardware device, an ASIC, or the like. The illustrated embodiment of the host adapter system 416 might be deployed on a physical component board, where the local storage controller module 414, the network storage controller module 418, the server host bus connection 420, and the local RAM cache device 422 are all physically located on the physical component board.

The host adapter system 416 couples certain components of the data server 402 to one another. More specifically, the host adapter system 416 is suitably configured to couple the server bus 424 of the data server 402 to the local cache storage 406 and to the SAN 404. The server host bus connection 420 is compatible with the server bus 424, and the arrow 426 in FIG. 4 represents electrical, mechanical, and data connectivity between the server bus 424 and the host adapter system 416. Although not a requirement, an embodiment of the data server could utilize PCIe technology for the server bus 424 and the server host bus connection 420. Other embodiments could use PCI, PCI-X, or HyperTransport.

The local storage controller module 414 was mentioned briefly above. The local storage controller module 414 is coupled to, integrated in, or incorporated with the host adapter system 416. The local storage controller module 414 is used for management, control, and/or supervision of the local cache storage 406, and the local storage controller module 414 may, in turn, be controlled or managed by the request manager 419. Accordingly, the local storage controller module 414 is configured for compatibility with the particular format, platform, design, and type of media used by the local cache storage 406 (e.g., hard disk drive, flash memory, RAID, or other technology). Therefore, depending upon the embodiment, the local storage controller module 414 may be configured for compatibility with one or more of the following storage interface technologies, without limitation: SCSI; SAS; SATA; USB; FireWire; IDE; etc. The local storage controller module 414 may be realized as a physically distinct and separate integrated circuit or ASIC, or it may be combined with the network storage controller module 418, the local RAM cache device 422, and/or other elements or modules of the host adapter system 416, depending upon the embodiment.

The local storage controller module 414 is suitably configured to control writing of server-maintained data at the local cache storage 406, and to control reading of server-maintained data from the local cache storage 406 (as needed and/or requested by the data server 402). For example, the data server 402 might generate instructions associated with a write operation to write data to the local cache storage 406. The local storage controller module 414 can receive the write instructions and, in response to (and in accordance with) those instructions, the local storage controller module 414 will control, manage, or otherwise handle the storage of the data in the local cache storage 406 under the supervision of the host adapter system 416. As another example, the data server 402 can generate instructions associated with a read operation to read designated data that was previously written by the data server 402. The local storage controller module 414 can receive the read instructions and, in response to (and in accordance with) those instructions, the local storage controller module 414 can issue a local read request for the designated data. In this regard, the local read request is intended for the local cache storage 406, and the local read request will call for data stored in the local cache storage 406. In this manner, the local storage controller module 414 controls, manages, or otherwise handles the reading of the data from the local cache storage 406 under the supervision of the host adapter system 416.

The network storage controller module 418 is also coupled to, integrated in, or incorporated with the host adapter system 416. The network storage controller module 418 is used for management, control, and/or supervision of the SAN 404, and the network storage controller module 418 may, in turn, be controlled or managed by the request manger 419. Accordingly, the network storage controller module 418 is configured for compatibility with the particular format, platform, design, type of media, and other operating or functional requirements of the SAN 404. Moreover, depending upon the embodiment, the network storage controller module 418 may be configured for compatibility with one or more of the following storage interface technologies, without limitation: Fiber Channel; iSCSI; GbE; AoE; FCoE; FCIP; HyperSCSI; iFCP; InfiniBand; etc. The network storage controller module 418 may be realized as a physically distinct and separate integrated circuit or ASIC, or it may be combined with the local storage controller module 414, the local RAM cache device 422, and/or other elements or modules of the host adapter system 416, depending upon the embodiment.

The network storage controller module 418 is suitably configured to control writing of server-maintained data at the SAN 404, and to control reading of server-maintained data from the SAN 404 (as needed and/or requested by the data server 402). For example, the data server 402 might generate instructions associated with a write operation to write data to the SAN 404. The network storage controller module 418 can receive the write instructions and, in response to (and in accordance with) those instructions, the network storage controller module 418 will control, manage, or otherwise handle the storage of the data in the SAN 404 under the supervision of the host adapter system 416. As another example, the data server 402 can generate instructions associated with a read operation to read designated data that was previously written by the data server 402. The network storage controller module 418 can receive the read instructions and, in response to (and in accordance with) those instructions, the network storage controller module 418 can issue a network read request for the designated data. In this regard, the network read request is intended for the SAN 404, and the network read request will call for data stored in the SAN 404. In this manner, the network storage controller module 418 controls, manages, or otherwise handles the reading of the data from the SAN 404 under the supervision of the host adapter system 416.

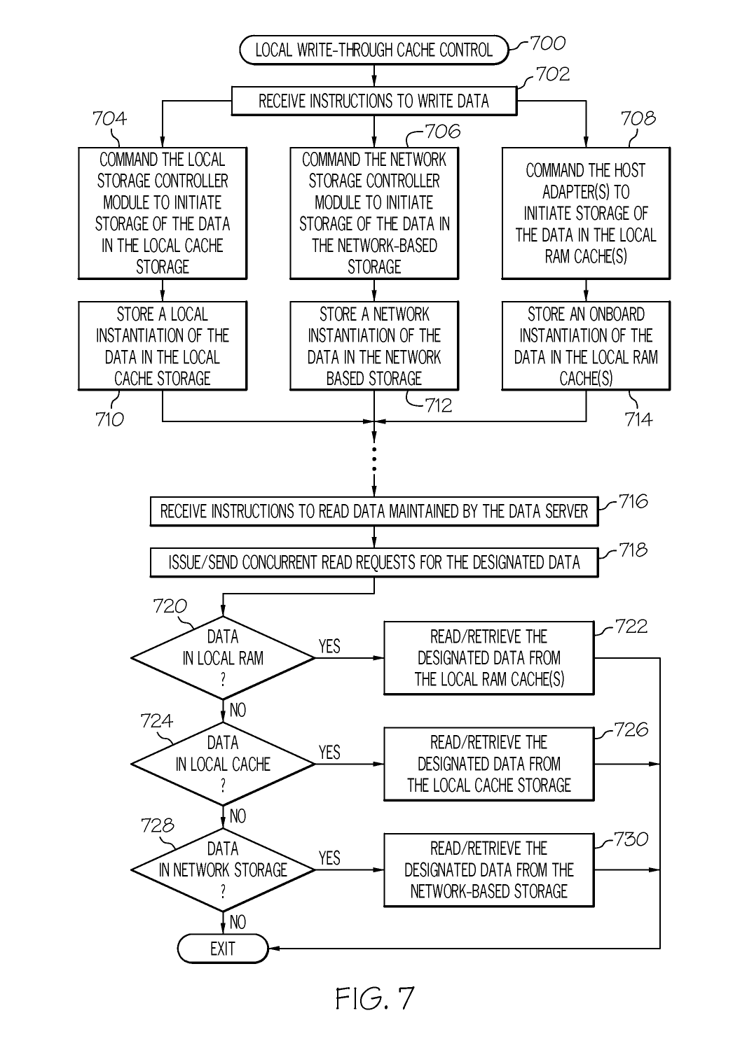

As explained in more detail below with reference to FIG. 7, in certain situations the local storage controller module 414 and the network storage controller module 418 cooperate to control redundant or duplicate writing of at least some server-maintained data at both the local cache storage 406 and the SAN 404. In other situations, the local storage controller module 414 and the network storage controller module 418 cooperate to concurrently issue local and network read requests for designated data (which might be stored at the local cache storage 406, the SAN 404, or both). This embodiment of the data server system 400 need not rely on the CPU to manage data movements and coordination between the SAN 404 and the local cache storage 406. Rather, the data request manager 419 represents a logical or functional module that is integrated into the host adapter system 416. The request manager 419 manages (or is a “master” to) the local storage controller 414 and the network storage controller 418 (which act as “slaves”). In operation, the request manager 419 is the recipient of data movement requests from the CPU of the system 400, and the request manager controls, manages, or otherwise supervises collecting/storing of data from/to the local cache storage 406 and the SAN 404.

Although not required, the illustrated embodiment of the data server 402 includes the local RAM cache device 422, which may be coupled to, integrated in, or incorporated with the host adapter system 416. In this regard, the local RAM cache device 422 may be realized as one or more physically distinct and separate RAM chips, or it may be combined with the local storage controller module 414, the network storage controller module 418, and/or other elements or modules of the host adapter system 416, depending upon the embodiment. For the illustrated embodiment, the local RAM cache device 422 is physically located on the physical component board, plug-in card, motherboard, or substrate used for the host adapter system 416, along with the local storage controller module 414 and the network storage controller module 418. In this regard, the local RAM cache device 422 may be referred to as “onboard” memory of the host adapter system 416.

In certain scenarios, the local RAM cache device 422 is utilized to redundantly store at least some of the same server-maintained data that is written to the SAN 404 (and, possibly, to the local cache storage 406). For reasons that will become apparent from the following description, the local RAM cache device 422 could be implemented to accelerate the write-through cache operations (reading and writing) supported by the data server system 400.

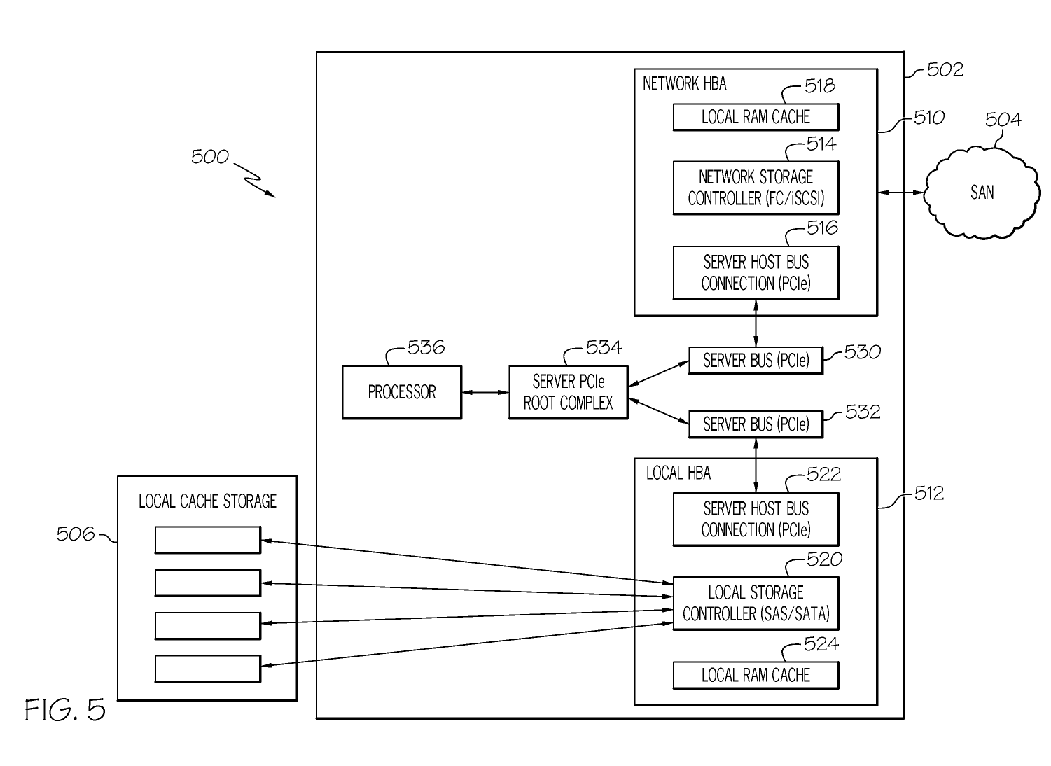

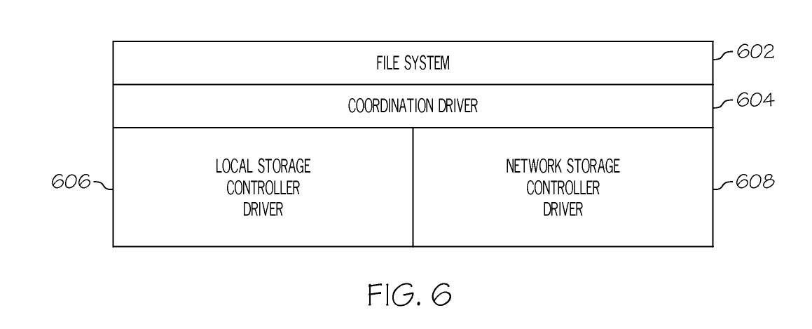

The data server system 400 utilizes an exemplary hardware-based solution to achieve the write-through local cache functionality. Alternate implementations could be suitably designed to support software-based solutions that need not employ customized or new hardware devices, cards, or components. In this regard, FIG. 5 is a schematic representation of an embodiment of a data server system 500 that utilizes a software-based approach, and FIG. 6 is a diagram of exemplary software/logical components associated with the data server system 500. Some of the elements, features, components, and functionality of the data server system 500 are similar, identical, or equivalent to counterparts described above for the data server system 400. For the sake of brevity and simplicity, such common items will not be redundantly described here in the context of the data server system 500.

The data server system 500 includes a data server 502, a network-based data storage architecture (e.g., a SAN 504), and a non-network-based nonvolatile local cache storage 506, as generally described above. In contrast to the data server 402 depicted in FIG. 4, the data server 502 utilizes a network host bus adapter 510 and a local host bus adapter 512. For this embodiment, the network host bus adapter 510 includes, without limitation, a network storage controller module 514, a host bus connection 516, and a local RAM cache device 518, and the local host bus adapter 512 includes, without limitation, a local storage controller module 520, a host bus connection 522, and a local RAM cache device 524. The network host bus adapter 510 and the local host bus adapter 512 may each be implemented on, realized as, or integrated into a respective plug-in card, a physical component board, a circuit board, a motherboard, a logical module, a hardware device, an ASIC, or the like. The illustrated embodiment of the data server 502 uses at least one physical card or board for the network host bus adapter 510 and at least one physically distinct and separate card or board for the local host bus adapter 512. For example, the network storage controller module 514, the host bus connection 516, and the local RAM cache device 518 could be physically located on a first card or board that is associated with the network host bus adapter 510, and the local storage controller module 520, the host bus connection 522, and the local RAM cache device 524 could be physically located on a second and different card or board that is associated with the local host bus adapter 512. Indeed, the network host bus adapter 510 and/or the local host bus adapter 512 could be realized as separate off-the-shelf hardware components. This aspect is desirable for the software-based solution described here.

The network host bus adapter 510 is suitably configured to couple the data server 502 to the SAN 504. For this embodiment, the server bus 530 represents a physical interconnect between the host bus connection 516 and the PCIe root complex 534. The host bus connection 516 is compatible with the server bus 530, and these elements utilize PCIe technology in certain embodiments. Similarly, the local host bus adapter 512 is suitably configured to couple the data server 502 to the local cache storage 506, and the server bus 532 represents a physical interconnect between the host bus connection 522 and the PCIe root complex 534. The host bus connection 522 is compatible with the server bus 532, and these elements utilize PCIe technology in certain embodiments. For such a PCIe embodiment, the data server 502 employs the PCIe root complex 534, which couples the processor 536 and system memory (not shown in FIG. 5) to the network host bus adapter 510 and to the local host bus adapter 512. In accordance with conventional PCIe technology, the root complex 534 is used to generate transaction requests, including read and write requests, on behalf of the processor 536. It should be understood that the PCIe root complex 534 represents one implementation-specific example of how physical cards for the network host bus adapter 510 and the local host bus adapter 512 can be connected in or to the data server system 500.

In contrast to the operation of the host adapter system 416 (see FIG. 4), the data server 502 manages, instructs, and supervises data writing and reading (via the network storage controller module 514 and the local storage controller module 520) using a software approach. In other words, the processor 536 communicates read/write requests to the network host bus adapter 510 and the local host bus adapter 512 as needed to control how data is accessed and stored at the local cache storage 506 and the SAN 504. Referring now to FIG. 6, the data server 502 includes a file system 602 (as described above with reference to FIG. 3), a local cache coordination driver 604, a local storage controller driver 606, and a network storage controller driver 608. The items shown in FIG. 6 may be realized as computer-executable software or files that reside in the system memory of the data server 502. (As is well understood, drivers exist as files on a file system, both of which are stored in a storage device. Drivers are loaded into memory and are then executed by the CPU of the system). In operation, the coordination driver 604 initiates data read and write requests to the local storage controller driver 606 and to the network storage controller driver 608 as needed. In this regard, the coordination driver 604 may cooperate with the file system 602.

The coordination driver 604 is operatively coupled to the local storage controller module 520 and to the network storage controller module 514. The coordination driver 604 can therefore coordinate between the two storage controller drivers 606/608 within the software levels. Each hardware-based host bus adapter 510/512 can utilize its own local RAM cache device 518/524, however, the coordination driver 604 will ensure that data is written by both the local storage controller module 520 and the network storage controller module 514. Data reading operations, originating from the coordination driver 604, will initiate read requests for both the local storage controller driver 606 and the network storage controller driver 608. In this manner, the coordination driver 604 can supervise and manage data storage and reading operations carried out by the storage controller drivers 606/608.

Although the two data server embodiments described here employ different hardware and software architectures, they both support data reading and writing for a locally attached, non-network-based, nonvolatile write-through cache device and a network-based data storage architecture. In this regard, FIG. 7 is a flow chart that illustrates a local write-through cache control process 700, which may be performed by either of the two data server embodiments described above. Although the detailed implementation and execution of the process 700 may vary from one embodiment to another, the general and overall methodology of the process 700 remains the same. The various tasks performed in connection with process 700 may be performed by software, hardware, firmware, or any combination thereof. For illustrative purposes, the following description of process 700 may refer to elements mentioned above in connection with FIGS. 1-6. In practice, portions of process 700 may be performed by different elements of the described system, e.g., a processor, a host adapter, a storage controller, or a media storage device. It should be appreciated that process 700 may include any number of additional or alternative tasks, the tasks shown in FIG. 7 need not be performed in the illustrated order, and process 700 may be incorporated into a more comprehensive procedure or process having additional functionality not described in detail herein. Moreover, an implementation of the process 700 could omit or bypass one or more tasks depicted in FIG. 7 (as long as the intended functionality of process 700 is preserved).

The illustrated embodiment of the process 700 assumes that the data server machine intends to write some amount data (e.g., application data) to a storage media device. Thus, an element, module, or component of the data server receives appropriate instructions to write data (task 702). In practice, such instructions may be issued by the host processor of the data server and then routed as needed and as appropriate for the particular embodiment. In practice, these instructions cause the process 700 to initiate storage of the data at the local cache storage and the network-based storage architecture. In certain embodiments, these instructions also cause the process 700 to initiate storage of at least some of the data at a local RAM cache that resides on a host adapter card or board (this additional writing of at least some of the data is optional).

For this embodiment, the data server commands the local storage controller module to initiate storage of the data in the local cache storage (task 704), and commands the network storage controller module to initiate redundant storage of the same data in the network-based storage architecture (task 706). FIG. 7 also depicts an optional branch of the process 700, where the data server commands one or more host adapters to initiate storage of at least some of the data in one or more local RAM cache devices (task 708). To reduce latency and improve performance, the commands associated with tasks 704, 706, and 708 can be issued and/or executed concurrently or simultaneously. Alternatively, these commands could be issued and/or executed in a sequential manner, and in any desired order.

In response to the command issued during task 704, the process 700 stores a local instantiation of the data in the local cache storage (task 710). Likewise, in response to the command issued during task 706, the process 700 stores a network instantiation of the same data in the network-based storage architecture (task 712). Similarly, in response to a command issued during task 708, the process 700 stores an onboard instantiation of at least some of the data in the local RAM cache device(s) (task 714). For improved writing speed and performance, the process 700 can initiate or execute tasks 710, 712, and 714 concurrently or simultaneously. Under certain circumstances, however, the redundant storage of the data could be initiated or executed in a sequential manner, and in any designated order. For example, it may be desirable to store the data in the network-based storage architecture after storage of the same data has been completed (or initiated) at the local cache storage. Notably, the local cache storage functions as a write-through element in that data written to the network-based storage architecture will also be written to the local cache storage to ensure redundancy.

This description assumes that the process 700 will eventually be used to read some server-maintained data. The ellipses in FIG. 7 indicate that any amount of time may pass between a write operation and a subsequent read operation. At some point, an element, module, or component of the data server receives appropriate instructions to read data that is maintained by the data server (task 716). In practice, such instructions may be issued by the host processor of the data server and then routed as needed and as appropriate for the particular embodiment. In practice, these instructions cause the process 700 to initiate a read operation for the designated data. For this embodiment, the read instructions result in concurrent read requests for the designated data, which may be located at the local cache storage, the network-based storage architecture, and/or the local RAM cache. Thus, the process 700 may issue or send concurrent local and network read requests (task 718) to the local storage controller module and the network storage controller module. If supported, the process 700 may also issue or send a concurrent read request to the local RAM cache device. Although concurrent read requests are desirable to decrease processing latency and reduce read times, it should be appreciated that the read requests could be issued and/or executed in a sequential or non-concurrent manner, and in any desired order. For example, the process 700 could instead generate and send a first read request to the local RAM cache, followed by a second read request to the local cache storage (if needed), and thereafter followed by a third read request to the network-based storage architecture (if needed).

If a local RAM cache is implemented and supported by the data server, then there will be three possible sources of the requested data: the local RAM cache; the local cache storage; and the network-based storage architecture. Thus, if the requested data resides in a local RAM cache (query task 720), then the designated data can be read or retrieved from the local RAM cache(s) (task 722). If the requested data instead resides in the local cache storage (query task 724), then the designated data can be read or retrieved from the local cache storage (task 726) using the local storage controller module. If, however, the requested data is not locally available and instead resides in the network-based storage architecture (query task 728), then the data server will read or retrieve the designated data from the network-based storage architecture (task 730) using the network storage controller.

The data server may be suitably configured to favor data that is locally stored, to reduce latency. Thus, if the requested data is stored in a local RAM cache device, then it may not be necessary to interrogate the local storage controller module and the network storage controller module. Similarly, if the requested data is stored in the local cache storage, then it may not be necessary to interrogate the network storage controller module. In other words, it may be desirable to read the requested data from the network-based storage architecture only if the requested data is not otherwise available from a local source. If for some reason the requested data is not found, then the process 700 may exit, generate an error flag or message, or re-enter itself at an appropriate point in an attempt to read the designated data again.

The techniques and methodologies described here enable a data server machine to control both a locally attached, non-network-based, write-through cache device and a network-based storage architecture to perform respective data writing and reading operations for data maintained by the data server machine. As a result, server-maintained data can be redundantly stored at both the local cache storage and the network-based storage architecture. The data server machine can also issue concurrent local and network read requests for designated data that is maintained by it, which results in better performance (e.g., lower read latency), especially when the requested data resides in the locally attached cache device.

The embodiments described here relate to an implementation where only one data server writes data to the network storage. In practice, a network-based storage architecture such as a SAN could be used to provide a plurality of data servers with shared access to common data. In such an environment, certain techniques and processes could be deployed to ensure that changes to server-maintained data can be consistently managed by all of the data servers. For example, if any one of the data servers makes changes to some server-maintained data, any outdated versions of that data will need to be purged or updated at the locally attached cache devices and/or at the local RAM cache devices supported by the other data servers.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a data server system comprising a data server, a network-based data storage architecture coupled to the data server, and a non-network-based nonvolatile write-through cache device locally attached to the data server, the method comprising:
receiving instructions to write data;
controlling storage of the data in the non-network-based nonvolatile write-through cache device, in accordance with the instructions; and
controlling redundant storage of the data in the network-based data storage architecture, in accordance with the instructions, such that redundant instantiations of the data are stored at the non-network based write-through cache device and at the network-based data storage architecture.

2. The method of claim 1, wherein controlling storage of the data in the non-network-based nonvolatile write-through cache device and controlling redundant storage of the data in the network-based data storage architecture are performed concurrently.

3. The method of claim 1, wherein storage of the data in the network-based data storage architecture is performed after storage of the data in the non-network-based nonvolatile write-through cache device.

4. The method of claim 1, wherein:
the data server comprises a host adapter module, a local storage controller module coupled to or integrated in the host adapter module, and a network storage controller module coupled to or integrated in the host adapter module, the local storage controller module operatively coupled to the non-network-based nonvolatile write-through cache device, and the network storage controller module operatively coupled to the network-based data storage architecture;
controlling storage of the data in the non-network-based nonvolatile write-through cache device is performed by the local storage controller module under supervision of the host adapter module; and
controlling redundant storage of the data in the network-based data storage architecture is performed by the network storage controller module under supervision of the host adapter module.

5. The method of claim 1, wherein:
the data server comprises a local storage controller module operatively coupled to the non-network-based nonvolatile write-through cache device, a network storage controller module operatively coupled to the network-based data storage architecture, and a local cache coordination driver operatively coupled to the local storage controller module and the network storage controller module;
controlling storage of the data in the non-network-based nonvolatile write-through cache device is performed by the local storage controller module under supervision of the local cache coordination driver; and
controlling redundant storage of the data in the network-based data storage architecture is performed by the network storage controller module under supervision of the local cache coordination driver.

6. The method of claim 1, wherein the data server comprises a local random access memory (RAM) cache device, and wherein the method further comprises controlling storage of at least some of the data in the local RAM cache device, such that redundant instantiations of at least some of the data are stored at the non-network-based write-through cache device, at the network-based data storage architecture, and at the local RAM cache device.

7. The method of claim 1, further comprising:
receiving instructions to read the data; and
sending concurrent read requests for the data, the concurrent read requests being associated with the network-based data storage architecture and the non-network-based nonvolatile write-through cache device.

8. The method of claim 7, further comprising:
reading the data from the non-network-based nonvolatile write-through cache device if the data is stored therein; and
reading the data from the network-based data storage architecture if the data is not stored in the non-network-based nonvolatile write-through cache device.

9. A method of operating a data server system comprising a data server, a network-based data storage architecture coupled to the data server, and a non-network-based nonvolatile write-through cache device locally attached to the data server, the method comprising:
receiving instructions to read designated data that was previously written by the data server;
issuing a local read request for the designated data, the local read request calling for data stored in the non-network-based nonvolatile write-through cache device; and
issuing a network read request for the designated data, the network read request calling for data stored in the network-based data storage architecture.

10. The method of claim 9, wherein sending the local read request and sending the network read request are performed concurrently.

11. The method of claim 9, wherein sending the network read request is performed after sending the local read request.

12. The method of claim 9, wherein:
the data server comprises a host adapter module, a local storage controller module coupled to or integrated in the host adapter module, and a network storage controller module coupled to or integrated in the host adapter module, the local storage controller module operatively coupled to the non-network-based nonvolatile write-through cache device, and the network storage controller module operatively coupled to the network-based data storage architecture; and
the method further comprises:
reading, with the local storage controller module and under supervision of the host adapter module, the designated data from the non-network-based nonvolatile write-through cache device when the designated data resides therein; and
reading, with the network storage controller module and under supervision of the host adapter module, the designated data from the network-based data storage architecture when the designated data does not reside in the non-network-based nonvolatile write-through cache device.

13. The method of claim 9, wherein:
the data server comprises a local storage controller module operatively coupled to the non-network-based nonvolatile write-through cache device, a network storage controller module operatively coupled to the network-based data storage architecture, and a local cache coordination driver operatively coupled to the local storage controller module and the network storage controller module; and
the method further comprises:
reading, with the local storage controller module and under supervision of the local cache coordination driver, the designated data from the non-network-based nonvolatile write-through cache device when the designated data resides therein; and
reading, with the network storage controller module and under supervision of the local cache coordination driver, the designated data from the network-based data storage architecture when the designated data does not reside in the non-network-based nonvolatile write-through cache device.

14. The method of claim 9, wherein the data server comprises a local random access memory (RAM) cache device, and wherein the method further comprises sending a RAM read request for the designated data, the RAM read request calling for data stored in the local RAM cache device.

15. The method of claim 14, wherein sending the local read request, sending the network read request, and sending the RAM read request are performed concurrently.

16. A host adapter system for a data server, the host adapter system comprising:
a local storage controller module for a locally attached nonvolatile write-through cache device of the data server, the local storage controller module being configured to control writing of server-maintained data at the locally attached nonvolatile write-through cache device; and
a network storage controller module for a network-based data storage architecture of the data server, the network storage controller module being configured to control duplicate writing of the server-maintained data at the network-based storage architecture;
wherein the local storage controller module issues a local read request for designated data maintained by the data server, the local read request being intended for the locally attached nonvolatile write-through cache device, and wherein the network storage controller module concurrently issues a network read request for the designated data, the network read request being intended for the network-based storage architecture.

17. The host adapter system of claim 16, further comprising a physical component board, the local storage controller module and the network storage controller module being physically located on the physical component board.

18. The host adapter system of claim 17, further comprising a local random access memory (RAM) cache device configured to redundantly store at least some of the server-maintained data, the local RAM cache device being physically located on the physical component board.

19. The host adapter system of claim 16, further comprising:
a local host bus adapter card, the local storage controller module being physically located on the local host bus adapter card; and
a network host bus adapter card, the network storage controller module being physically located on the network host bus adapter card.

20. The host bus adapter system of claim 19, further comprising a local random access memory (RAM) cache device configured to redundantly store at least some of the server-maintained data, the local RAM cache device being physically located on the local host bus adapter card.

21. The host bus adapter system of claim 19, further comprising a local random access memory (RAM) cache device configured to redundantly store at least some of the server-maintained data, the local RAM cache device being physically located on the network host bus adapter card.

22. The host bus adapter system of claim 16, wherein the local storage controller module is configured for compatibility with a storage interface technology selected from the group consisting of: Small Computer System Interface (SCSI); Serial Attached Small Computer System Interface (SAS); Serial Advanced Technology Attachment (SATA); Universal Serial Bus (USB); FireWire; and Integrated Drive Electronics (IDE).

23. The host bus adapter system of claim 16, wherein the network storage controller module is configured for compatibility with a storage interface technology selected from the group consisting of: Fiber Channel; Internet Small Computer System Interface (iSCSI); Gigabit Ethernet (GbE); Advanced Technology Attachment over Ethernet (AoE); Fiber Channel over Ethernet (FCoE); Fiber Channel over IP (FCIP); HyperSCSI; and Internet Fiber Channel Protocol (iFCP).

24. The host adapter system of claim 16, wherein:
the network-based data storage architecture comprises a storage area network; and
the network storage controller module is configured for compatibility with the storage area network.

25. The host adapter system of claim 16, wherein:
the locally attached nonvolatile write-through cache device comprises at least one hard disk drive; and
the local storage controller module is configured for compatibility with the at least one hard disk drive.

26. The host adapter system of claim 16, wherein:
the locally attached nonvolatile write-through cache device comprises a Redundant Array of Independent Disks (RAID); and
the local storage controller module is configured for compatibility with the RAID.

27. The host adapter system of claim 16, wherein:
the locally attached nonvolatile write-through cache device comprises at least one flash memory element; and
the local storage controller module is configured for compatibility with the at least one flash memory element.

28. A computer-readable medium having computer-executable instructions stored thereon that, when executed by a data server machine, cause the data server machine to perform a method comprising:
controlling a locally attached nonvolatile write-through cache device of the data server machine to perform local write and read operations for data maintained by the data server machine; and
controlling a network-based storage architecture of the data server machine to perform network write and read operations for data maintained by the data server machine, such that server-maintained data is redundantly stored at both the locally attached nonvolatile write-through cache device and the network-based storage architecture.

29. The computer-readable medium of claim 28, wherein the computer-executable instructions, when executed by the data server machine, cause the data server machine to:
issue a local read request to the locally attached nonvolatile write-through cache device for designated data maintained by the data server machine; and
concurrently issue a network read request to the network-based storage architecture for the designated data.

30. The computer-readable medium of claim 28, wherein the computer-executable instructions, when executed by the data server machine, cause the data server machine to:
read the designated data from the locally attached nonvolatile write-through cache device if the designated data is stored therein; and
read the designated data from the network-based data storage architecture if the designated data is not stored in the locally attached nonvolatile write-through cache device.
